(19) United States
(12) Patent Application Publication
(10) Pub. No.: US 2013/0262008 A1
(43) Pub. Date: Oct. 3, 2013

(54) MEASUREMENT OF LIGHT-ABSORPTION QUALITIES IN THE VISIBLE SPECTRUM USING A CAMERA

(71) Applicants: Nithya RAMANATHAN, Los Angeles, CA (US); Martin Ladislav LUKAC, Los Angeles, CA (US)

(72) Inventors: Nithya RAMANATHAN, Los Angeles, CA (US); Martin Ladislav LUKAC, Los Angeles, CA (US)

(21) Appl. No.: 13/476,817

(22) Filed: May 21, 2012

Related U.S. Application Data
(60) Provisional application No. 61/616,712, filed on Mar. 28, 2012.

(51) Int. Cl. G01N 21/55; G06F 17/10

(52) U.S. Cl. CPC G01N 21/55; G06F 17/10
USPC 702/85

(57) ABSTRACT

To analyze a sample, an image comprising a calibration chart region and a representation of the sample is accessed. The calibration chart region has multiple reference markers. The reflectance value for each of the reference markers is determined. In one example, the reflectance value may be reflectance values in the red wavelength. Each of the reflectance values is associated with a quantity value corresponding to the reference markers. An exponential function relating the reflectance values and the associated quantity values is determined. The reflectance value for the representation of the sample is determined. In one example, the reflectance value for the sample may be the reflectance value in the red wavelength. A quantity value of the sample is determined based on evaluating the exponential function using the sample reflectance value.

### CROSS REFERENCE TO RELATED APPLICATION

The present application claims benefit to previously filed provisional patent application Ser. No. 61/616,712, entitled “MEASUREMENT OF LIGHT-ABSORPTION QUALITIES IN THE VISIBLE SPECTRUM,” filed on Mar. 28, 2012, and for which the entire content is incorporated herein by reference for all purposes.

### STATEMENT REGARDING FEDERALLY SPONSORED RESEARCH

This invention was made with government support under grant #AGS-1016496 awarded by the National Science Foundation. The government may have certain rights in the invention.

### BACKGROUND

1. Field

The present disclosure relates to data analysis and, more specifically, to systems and processes for collecting, measuring, and analyzing light-absorption qualities of a sample in the visible spectrum.

2. Related Art

Scientific evidence has shown that the incomplete combustion of fossil fuel and the burning of biomass fuels, such as wood, dung, and crop residues, generate black carbon (BC), a major contributor to global warming. In addition to BC's climate impacts, the inhalation of smoke containing BC results in more than 1.8 million deaths per year.

Systems and processes to measure near-surface BC mass concentrations ([BC]) globally are necessary to validate air pollution and climate models and to evaluate the effectiveness of BC mitigation actions. Although some commercial BC monitoring methods are available, such as the Aethalometer from Magee Scientific, their wide-spread use for BC data collection is problematic because of their complexity and the prohibitive costs associated with them.

Therefore, there is a need for an improved method of conveniently collecting and analyzing BC data from many locations, households, or individuals at a low cost.

### SUMMARY

To analyze a sample, an image comprising a calibration chart region and a representation of the sample is accessed. The calibration chart region has multiple reference markers. The reflectance value for each of the reference markers is determined. In one example, the reflectance value may be reflectance values in the red wavelength. Each of the reflectance values is associated with a quantity value corresponding to the reference markers. An exponential function relating the reflectance values and the associated quantity values is determined. The reflectance value for the representation of the sample is determined. In one example, the reflectance value for the sample may be the reflectance value in the red wavelength. A quantity value of the sample is determined based on evaluating the exponential function using the sample reflectance value.

In one embodiment, the exponential function relates reflectance values with quantity values based on the natural exponent (e) raised to the power of the product of an exponent value and an input reflectance value. The sample reflectance value is used as an input to the exponential function.

In one embodiment, the exponent value of the exponential function is between −0.001 and −0.1. In another embodiment, the exponent value of the exponential function is between −0.01 and −0.02.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary process for collecting training information, creating a reference scale, and analyzing a sample.

FIG. 2 illustrates an exemplary template including a reference scale, spatial locator, and test sample filter.

FIG. 3 illustrates an exemplary process for analyzing light-absorbing qualities of a sample.

FIG. 4 illustrates an exemplary computing system.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments.

Disclosed in the present application are systems and processes for analyzing a sample. In one example, the sample may be a filter with black carbon. An image, such as a digital image, comprising a calibration chart region and a representation of the sample is accessed. The calibration chart region has multiple reference markers. The reflectance value for each of the reference markers is determined. In one example, the reflectance value may be reflectance values in the red wavelength. Each of the reflectance values is associated with a quantity value corresponding to the reference markers. An exponential function relating the reflectance values and the associated quantity values is determined. The reflectance value for the representation of the sample is determined. In one example, the reflectance value for the sample may be the reflectance value in the red wavelength. A quantity value of the sample is determined based on evaluating the exponential function using the sample reflectance value.

As used herein, BC may refer to black carbon and [BC] may refer to black carbon mass concentration. BC may be a strongly light-absorbing component of soot that gives emissions, such as diesel engine exhaust and smoke plumes, their dark, brownish color.

Exemplary systems and processes described are particularly applicable to analyzing air quality data to determine near-surface [BC]. Thus, exemplary systems and processes are described below in this context. It should be recognized, however, that these exemplary systems and processes can be used to analyze other types of data for determining sample concentrations, such as the level of bilirubin in blood plasma, which may be indicative of levels of jaundice, or the color measurement and discoloration of skin caused by jaundice, and the like. These exemplary systems and processes may also be used in industrial air quality monitoring, medical pathogen detection, medical symptom detection, and the like.

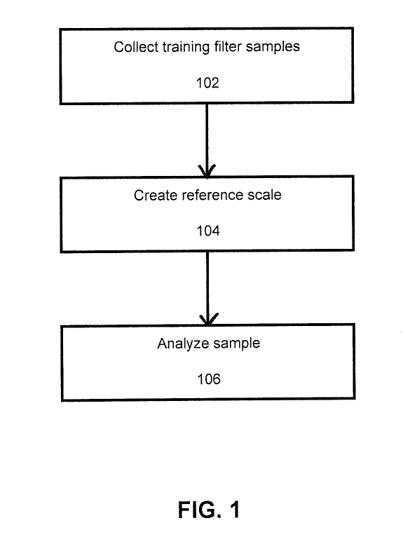

FIG. 1 illustrates an exemplary process for collecting training information, creating a reference scale, and analyzing a sample. In block 102, training filter samples may be collected. Various methods may be used to collect training filter samples of black carbon (BC), such as by using a filter-based aerosol sampler. The loading of BC on the filter of the various training filter samples may be varied to provide an assortment of training points. For example, the loading of BC on the various training filter samples may be varied by varying the [BC], the exposure duration of the sample, or the location where the sample is taken. Thus, some training filter samples may have higher amounts of BC than other training filter samples.

In order to collect the training filter samples, the aerosol sampler may be configured to draw in air through a filter. As more BC passes through the filter, the BC loading on the filter may increase. The units of BC loading of a sample may be, for example, 0.1 to 30 [μg cm⁻²].

In one example, a Miniaturized Aerosol filter Sampler (MAS) system may be used to collect samples. The MAS may, for example, include four main components: (i) an air pump, (ii) a filter holder, (iii) a power supply, and (iv) control electronics. The air pump may be, for example, a micro air pump, a vacuum pump, or a low-power pump. In one example, the air pump may be an AAA series micro air pump model-20 manufactured by Sensidyne Inc. The filter holder may be, for example, a 25-mm diameter closed aluminum filter holder. In one example, the filter holder may be an aluminum filter holder produced by BGI Inc. of Waltham, Mass. The power supply may be, for example, a battery for continuous power supply or an AC-to-DC adapter drawing power from an AC source. The air pump may draw air through a filter, such as a 25-mm diameter quartz filter, placed inside the filter holder, and may operate at a maximum flow rate of 625 cc min⁻¹.

In one example, a flow meter, such as a digital flow meter, may be included as part of the MAS to monitor and log the flow rate of air, as constant flow rate may improve measurement reliability. The control electronics may have a DC-DC converter to provide a steady 12-V supply. The control electronics may control the pump flow rate.

Multiple BC sample filters may be collected using the MAS system. All of these filters, a random subset of these filters, or a determined subset of these filters may be selected for the training dataset for a calibration curve. In order to determine the BC loading associated with each training filter, a reference unit, such as the 7-wavelength λethalometer (model AE-31), may be used side by side with the MAS system. For example, BC aerosols may be collected by the MAS and the Aethalometer through a common aerosol inlet. The Aethalometer data may be used to calculate the BC loading (BC₁) for each filter using the following equation:

$${BC}_{l} [ μg \text{/} {cm}^{2} ] = \frac{{[ BC ]}_{Aethalometer} [ μg \text{/} {m}^{3} ] \times {V}_{f} [ {m}^{3} ]}{A [ {cm}^{2} ]}$$

A[cm²] may be the area of the spot occupied by the BC particles deposited on the MAS filter, and may be constant across filters. Equivalently, A[cm²] may be the area of the filter exposed to BC. For example, A=2 cm². V_{f} [m³] may be the volume of air that passes through the filter in the MAS, and may be different for each sample. It may be the product of the MAS pump's mean flow rate, F[m³ min⁻¹], and the duration the filter was exposed in the MAS system, D[min], which may vary and may need to be measured for each filter: V_{f}=F[m³ min⁻¹]×D[min]. F may be measured before a MAS is deployed for field use, and F may also be logged by a MAS sub-system, as constant flow rate may be critical for measurement reliability. [BC]_{Aethalometer} may be the [BC] reported by the Aethalometer reference unit at 880 nm. Transmission data may be captured at 880 nm for determining [BC] because absorption of radiation of other aerosols (e.g., organic aerosols) may be negligible at 880 nm. Using this information, the BC loading of a sample may be associated with the [BC] for the sample.

At block 104, a reference scale may be created. In order to create the reference scale, an image of each training filter sample may be used to determine the reflectance of the BC particles accumulated on the training filter samples. The image may be, for example, a digital image. Light absorption may not be accurately obtained from a single wavelength when the determination of color for a training sample is done using a digital image. Instead, a coarse absorption process may be used to analyze the image of each training filter sample and to calculate the spectral dependence of absorption. This may be computed across ranges of wavelengths, specifically across: the red (620 nm to 750 nm), green (495 nm to 570 nm), and blue (450 nm to 475 nm) wavelengths in the visible spectrum for each training filter.

More specifically, the images of the training filter samples may be used to determine the reflectance in the red wavelength (ρ_{red}) of the BC particles accumulated on each training filter. This may be done, for example, by digitizing each training filter sample into a computer and then using image processing to determine ρ_{red} of the BC particles accumulated on the filter. For example, reflectance in the red spectrum may correspond to wavelengths of approximately 620 nm to 750 nm or approximately 630 nm to 740 nm.

In one example, the training filter samples may be digitized by using a commercially available flatbed color digital scanner (e.g., an Epson Perfection 4490 Photo scanner). ρ_{red} may then be determined from the digitized images of the training filter samples using a photo-editing tool, such as the GNU Image Manipulation Program (Gimp). In another example, a colorimeter or spectrophotometer may be used in order to more directly measure the reflectance directly from the filter paper.

Once the ρ_{red} value of each training filter sample is known, it may be associated with the BC loading for each corresponding training filter sample. A calibration function, f, may be determined to relate ρ_{red} values to their corresponding BC loading values. The relationship between ρ_{red} and BC loading may be exponential, where ρ_{red} is an input reflectance. The exponential fit-line may have an r² of 0.97, and may be represented with the equation:

BCₗ[μg/cm²]=f_{sf}(ρ_{red})=−0.715+172.6045×e^{-0.0183×ρ}^{_{red}}

The calibration function may change based on the instrument that is used to calibrate the training filters, or may change based on the ambient conditions present (e.g. dust, source of aerosol). For the following equation, in one example, values for a may range from −100 to 100, values for b may range from −1000 to 1000, and values for c may range from −0.001 to −0.1. In another example, values for a may range from −50 to 50, values for b may range from −500 to 500, and values for c may range from −0.01 to −0.02.

BCₗ[μg/cm²]=f_{sf}(ρ_{red})=a+b×e_{c×ρ}^{_{red}}

The reference scale may be created by identifying several points along the calibration curve (e.g., low BC loading to high BC loading). The calibration curve may be based on the calibration function, f. The reference scale may include reference markers. Each reference marker may be a different shade and may correspond to a ρ_{red} value and a BC loading value based on the identified points along the calibration curve. In one example, the reference markers may vary from light gray to dark gray.

In one embodiment of the reference scale, 10 points may be selected along the calibration curve. The points may be selected, for example, such that they are evenly spaced along the calibration curve. The corresponding ρ_{red} for each point may be used to create the 10 reference markers, each with a different shade or color, in a reference scale. The reference scale may be created through a printing process. Each shade of the printed referenced scale may correspond to the reflectance of the filter at a known BC loading value. In another embodiment, the reference markers may be, for example, based on scanned images of the training filter samples. A scanner, however, may introduce errors, such as including variations in exposure and gamma. In yet another embodiment, the shades of the reference markers may be generated using a photo-editing tool, rather than using actual scanned images, based on the determined color or shade of the training filter samples. This may help remove the variables introduced when a sample is digitized into an image and may ensure even distribution of the shade across the entire reference marker. However, the reference scale may comprise two, three, four, or more reference markers.

In order to minimize error introduced by different inks, papers, and printing processes, the reference scale may be printed using a recently profiled digital printer, such as a Noritsu QSS-3411 digital printer, so as to match the RGB values extracted from the scanned or generated images with the CMYK color space as accurately as possible. The reference scale may be printed along with a spatial locator, as described below, onto a template. The entire template, including the reference scale and spatial locator, may be printed with a matte finish in order to minimize glare that may arise when taking an image of the filter with an image sensor, such as a camera of a cell phone. Further, the reference markers of the reference scale may be arranged in a circular manner around a test sample filter location. This may reduce the glare that may arise when taking an image of the filter with an image sensor. One of skill in the art will readily appreciate that one may employ additional or alternative tactics to eliminate glare, reduce glare, or otherwise account for glare.

At block 106, a new sample, such as a test sample, may be analyzed. A test sample filter that has been exposed to BC, such as by using a MAS, may be placed on the template containing the reference scale. An image, such as a digital photographic image, of the filter and the template may be captured. An algorithm may be used to reconstruct the calibration curve for this image using the reference scale. The light absorption of the reference markers and the test sample filter may be measured across ranges of the red (620 nm to 750 nm), green (495 nm to 570 nm), and blue (450 nm to 475 nm) wavelengths in the visible spectrum. More specifically, a calibration curve may be constructed by extracting ρ_{red} for each reference marker in the reference scale and associating each value with the known BC loading of the corresponding reference marker. The ρ_{red} of the test sample filter may then be determined and used in conjunction with this calibration curve to obtain the BC loading of the test sample filter. For example, reflectance in the red spectrum may correspond to wavelengths of approximately 620 nm to 750 nm or approximately 630 nm to 740 nm Further, the [BC] associated with the sample filter may be determined based on the flow rate of the pump, the sampling duration, and/or the size of the area of the filter used to collect BC particles.

Block 102 and block 104 of FIG. 1 may be limited to a calibration process, which may only need to be performed once. The same reference scale may be used to analyze test samples collected at different times and in different regions. Block 106 may be performed independent of blocks 102 and 104, and may be used to determine BC loading information and [BC] measurements.

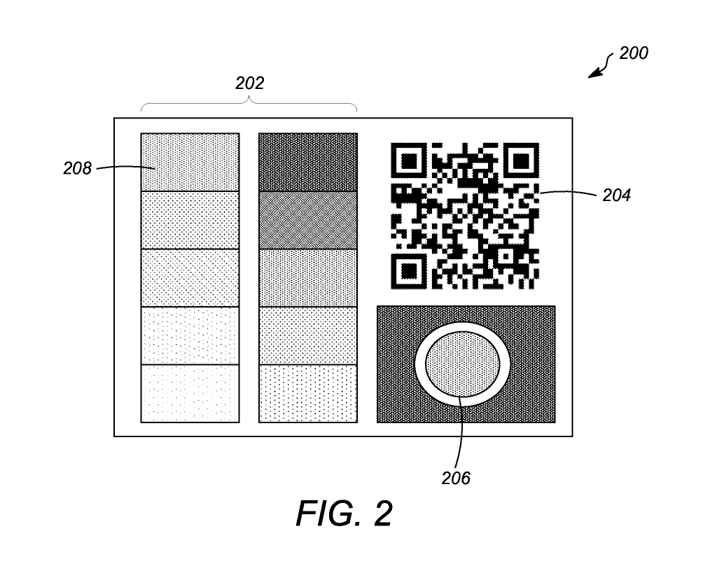

FIG. 2 illustrates an exemplary template 200 including a reference scale 202, spatial locator 204, and test sample filter 206. Reference scale 202 may include 10 reference markers, which vary from light to dark. Each reference marker may be a different shade (or color) and may correspond to a ρ_{red} value and a known BC loading value. For example, the shade (and thus the expected ρ_{red} value) and the BC loading value of reference marker 208 may be based on points identified along a calibration curve, as previously described.

The template 200 may include a spatial locator, such as QR code 204. The QR code 204 may be a fixed-size, two-dimensional bar code. The QR code 204 may be used to determine a rotation value, a stretch value, and other image manipulation values in order to calibrate the image. The conversion system may also use the QR code 204 as a landmark to locate or orient the reference scale 202 and test sample filter 206.

The test sample filter 206 may be placed with the template 200 after the test sample filter 206 has been exposed to BC. The exposure may be, for example, through the use of a MAS system. By placing the test sample filter 206 with the template 200, a single image may be taken of the template 200 that includes the test sample filter 206. The single image of the template 200 and test sample filter 206 may be used to determine the BC loading or [BC] of the test sample filter.

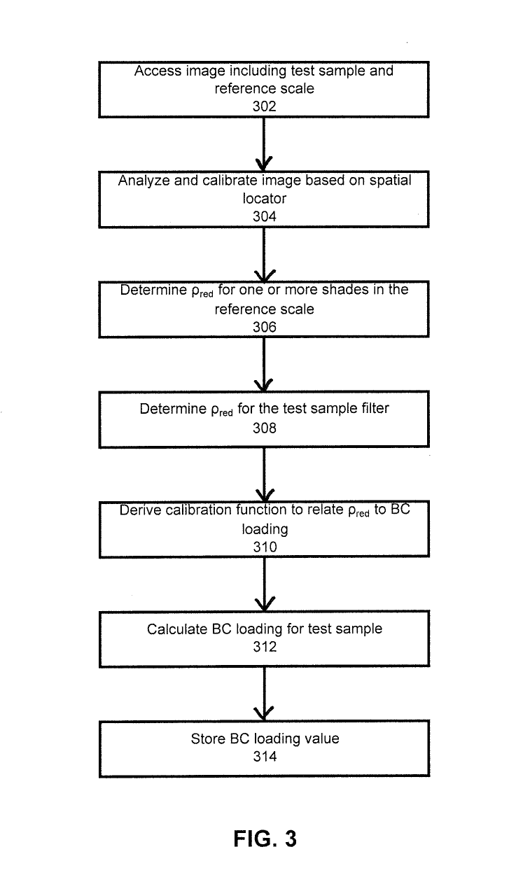

FIG. 3 illustrates an exemplary process for analyzing light-absorbing qualities of a sample using an image of the exemplary template 200. In general, the blocks of FIG. 3 may be performed in various orders, and in some instances may be performed partially or fully in parallel. Additionally, not all blocks must be performed. The determination of the BC loading and [BC] of a sample will now be described in detail with reference to FIG. 3.

At block 302, a conversion system may access an image that includes a reference scale and a representation of a test sample. For example, the image may have been created by removing an exposed filter from the filter holder of an aerosol filter sampler, placing it with a template 200, which may include a reference scale, and using an image sensor to capture an image of the test sample filter and template 200. For example, the camera of a cell phone may be used to capture the image. In one embodiment, the image may be transmitted, for example by MMS, email, or upload, via a cell phone to the conversion system for analysis. In another embodiment, a cell phone may include the conversion system, as well as a sensor configured to capture images.

In one example, a MAS system may be used to collect the test sample. As previously described, the MAS may, for example, include four main components: (i) an air pump, (ii) a filter holder, (iii) a power supply, and (iv) control electronics. The air pump may be, for example, a micro air pump, a vacuum pump, or a low-power pump. In one example, the air pump may be an AAA series micro air pump model-20 manufactured by Sensidyne Inc. A filter may be placed into the filter holder and air may be drawn through the filter by the air pump In one example, the filter holder may be an aluminum filter holder produced by BGI Inc. of Waltham, Mass. As the air is drawn through the test sample filter, BC particles may be deposited onto the filter. After a period of time, the filter may be removed from the MAS and placed alongside the reference scale. An image may be taken of the reference scale and test sample filter for analysis. Preferably, a single image will include both an image of the reference scale and an image of the test sample filter.

In one example, a flow meter, such as a digital flow meter, may be included as part of the MAS to monitor and log the flow rate of air, as constant flow rate may aid measurement reliability. The control electronics may have a DC-DC converter to provide a steady 12-V supply. The control electronics may control the pump flow rate. In one example, the control electronics of the MAS may control the pump to reduce the flow rate in highly polluted regions. This may limit the amount of BC collected on the test sample filter. In another example, the control electronics may control the pump to increase the flow rate in highly unpolluted regions. This may increase the amount of BC collected on the test sample filter. The control electronics may also control a sampling schedule. For example, the sampler may be turned on for shorter periods of time throughout the day, rather than running continuously for an extended duration, in order to save power. The control electronics may use a clock, such as a real-time 24-hour clock powered using an independent coin-battery power source, to initiate sampling or to track information related to a sample.

Additional information may also be collected. For example, the area of the spot occupied by the BC particles deposited on the test sample filter (A[cm²]) may be determined. For example, A=2 cm². The volume of air that passes through the test sample filter in the MAS (V_{f} [m³]) may also be determined. V_{f} [m³] may be the product of the MAS pump's mean flow rate, F[m³ min⁻¹], and the duration the test sample filter was exposed in the MAS system, D[min] Thus, V_{f}=F[m³ min⁻¹]×D[min]. F may be measured before the MAS is deployed for field use, and F may also be logged by a MAS sub-system, as constant flow rate may be critical for measurement reliability. Using this information, the [BC] for a sample may be determined based on the BC loading of the test sample filter.

At block 304, the conversion system may analyze the image for a spatial locator and calibrate the image. The image may be rotated, stretched, and otherwise transformed in order to identify the spatial locator or to calibrate the image based on the spatial locator. In one example, the spatial locator may be a QR code, which is a standard, fixed-size, two-dimensional bar code that the system may use to calibrate the size and position of all other elements on the image. The conversion system may also use the spatial locator as a landmark to locate or orient the reference scale. The conversion system may use the spatial locator and the reference scale to crop the image and reduce the search space required to determine the location of the filter in the image. The system may detect the set of pixels that it deems to most likely be the filter by, for example, running a circle detection method called from the openCV image analysis library. OpenCV is an open source computer vision library. This detection may be based on the size, shape, and expected location of the test filter sample in the image.

At block 306, the conversion system may determine ρ_{red} for each reference marker in the reference scale. For example, reflectance in the red spectrum may correspond to wavelengths of approximately 620 nm to 750 nm or approximately 630 nm to 740 nm. Alternatively, the system may conclude that determining the ρ_{red} for each reference marker in the reference scale may not be necessary, and thus may initially determine the ρ_{red} for a subset of reference markers in the reference scale. A set of pixels may be sampled and averaged from each reference marker in the image to minimize error when determining the value of ρ_{red} for each reference marker. Those skilled in the art will readily appreciate that many techniques may be used to determine the value of ρ_{red} for a reference marker.

At block 308, the system may analyze the image to determine ρ_{red} for the representation of the test sample filter. For example, reflectance in the red spectrum may correspond to wavelengths of approximately 620 nm to 750 nm or approximately 630 nm to 740 nm. A set of pixels may be sampled and averaged for the representation of the test sample filter in the image to minimize error. Those skilled in the art will readily appreciate that many techniques may be used to determine the value of ρ_{red} for the test sample filter.

Importantly, ρ_{red} may be a reliable indicator of absorption by BC. The RGB (red, green, blue) color space may be used to describe the reflectance of the BC particles from the image of the filter. ρ_{red} may be measured by extracting the red chromaticity of the filter from the image. This estimate of ρ_{red} for the BC accumulated on the filter may be used to accurately estimate the total loading of BC accumulated on the filter.

Typically, sources which emit BC also co-emit OC aerosols. Some of these OC aerosols, otherwise known as brown carbon, also absorb solar radiation. Absorption of solar radiation by brown carbon is particular strong in the ultraviolet regions; absorption in the near infrared region (e.g., greater than 800 nm) is negligible; and absorption in the red region (e.g., 620 to 750 nm) is less than 5% of the absorption in the ultraviolet regions (e.g., less than 400 nm). Therefore, the interference of OC aerosol absorption on the measurement of BC loading and [BC] may be small when analyzing the absorption in the red region. Accordingly, the filter's reflectance in the red wavelength may be related to the quantity of BC deposited on the filter. This may be irrespective of the source of BC or how those particles were deposited.

At block 310, the dataset of ρ_{red} for the reference markers and the corresponding known BC loading for the reference markers may be used to create a calibration function. Given ρ_{red} for the test sample filter, this calibration function may be used to calculate the BC loading for the test sample filter.

The system may determine the calibration function using an exponential fit-line based on the determined dataset of ρ_{red} for the reference markers and the corresponding known BC loading for the reference markers. This fit-line may be independent of the calibration function used to create the reference scale, as described in relation to block 104 in FIG. 1. The determined calibration marker may take the form of the following equation and, in one example, values for a may range from −100 to 100, values for b may range from −1000 to 1000, and values for c may range from −0.001 to −0.1. In another example, values for a may range from −50 to 50, values for b may range from −500 to 500, and values for c may range from −0.01 to −0.02.

BCₗ[μg/cm²]=f(ρ_{red})=a+b×e^{c×ρ}^{_{red}}

The spectral dependence for the sample may be used to determine what proportion of BC exists, compared with any other light-absorbing particulates. Spectral dependence of absorption may be quantified for each test sample using the Ångstrom exponent of absorption, defined as the negative slope of absorption versus wavelength in a log-log plot. Additionally, the BC measurement may be refined based on estimates of the presence of other light-absorbing particulates indicated by the spectral dependence.

One of the biggest variables influencing the measurement of color for a representation of a test sample filter in an image may be the particular camera used for acquiring the image of the filter. This is especially true for modern digital imaging devices that use sophisticated proprietary algorithms for color correction. Thus, it may be advantageous to capture both the filter and the reference scale in a single image when the image will be used to reconstruct the function, f. Under these circumstances, the process may assume that any ambient condition that will impact the calculation of ρ_{red} for the test sample filter will, in general, uniformly impact the calculation of ρ_{red} for the reference markers in the reference scale as well. The reference scale therefore permits the calculation of ρ_{red} to be calibrated for different ambient conditions (such as light levels, camera angles, aerosol composition, and the like), cameras, camera configurations, and in-camera image preprocessing techniques. Furthermore, because the reference scale may be present in each image, the conversion system may not depend on blank analysis for each sample.

At block 312, the conversion system may determine the corresponding BC loading value and [BC] value of the test sample filter based on the calibration function, f.

The system may use the determined ρ_{red} value from the sample filter in the image and the reconstructed calibration function in order to calculate the BC loading of a sample.

In one example, the conversion system may determine the BC loading of the test sample filter by using the reconstructed calibration function. An exemplary reconstructed calibration function based on an image of a reference scale may be:

BCₗ[μg/cm²]=f(ρ_{red})=−1.4233+35.6533×e^{-0.0150×ρ}^{_{red}}

Using a reconstructed calibration function, the conversion system may determine the BC loading value based on the ρ_{red} of the test sample filter. For example, the ρ_{red} of a test sample filter may be input into the reconstructed calibration function to determine the BC loading value.

One of skill in the art will readily appreciate that the reconstructed calibration function may be different for each analyzed image of a reference chart. For example, a reconstructed calibration function may change as a result of ambient conditions (such as light levels, camera angles, aerosol composition, and the like), cameras, camera configurations, and in-camera image preprocessing techniques. However, the reconstructed calibration function may be an exponential function determined based on the reference marker reflectance values and the associated known BC loading values for the reference markers. For example, the reconstructed calibration curve may be an exponential function that relates reflectance values with quantity values based on a determined scalar value (e.g., −1.4233) added to the product of a multiplier value (e.g., −35.6533) and the natural exponent (e) raised to the power of the product of a determined exponent value (e.g., −0.0150) and an input reflectance value.

Once the BC loading value is known, the [BC] value may be calculated using the following equation:

$$[ BC ] [ μg \text{/} {m}^{3} ] = \frac{{BC}_{l} [ μg \text{/} {cm}^{2} ] \times A [ {cm}^{2} ]}{{V}_{f} [ {m}^{3} ]}$$

A[cm²] may be the area of the spot occupied by the BC particles deposited on the MAS filter, and may be constant across filters. Equivalently, A[cm²] may be the area of the filter exposed to BC. For example, A=2 cm². V_{f} [m³] may be the volume of air that passed through the filter in the MAS. V_{f} may be the product of the MAS pump's mean flow rate, F[m³ min⁻¹], and the duration the filter was exposed in the MAS system, D[min]: V_{f}=F[m³ min⁻¹]×D[min]. F may be measured before a MAS is deployed for field use, and F may also be logged by a MAS sub-system, as constant flow rate may be critical for measurement reliability.

At block 314, the conversion system may store the BC loading or [BC] value of the test sample filter in memory. Additionally, or alternatively, the conversion system may transmit the determined BC loading value or [BC] value to another device for further analysis or for storage. In one embodiment, the conversion system may be a device (or may be implemented on a device) that incorporates an image sensor, such as a cell phone. This may allow the cell phone to capture an image of a test sample filter and analyze the image to determine the BC loading and/or [BC] value of the sample without the need to communicate with external devices or servers.

The methods and systems described herein may be used to support the analysis and evaluation of the light-absorption qualities of a physical sample based on the color of the sample derived from a digital photograph of the sample. Further, the methods for processing the sample may use an analysis of the light-absorption across ranges of wavelengths in the visible spectrum extracted from the digital representation of the sample.

Thus, to identify and measure the light absorption of a test sample, an electronic device may take, or access, a digital photograph of the sample and the medium on which it rests (for example, a quartz fiber air filter that has been exposed to air pollutants or a paper testing strip on which a blood sample has been deposited). The sample may be photographed alongside a calibrated reference chart that has a series of reference markers of varying colors or shades, each of which may be associated with a known quantity or concentration of the substance that is the subject of the testing (e.g., the level of bilirubin in blood plasma, which is indicative of levels of jaundice). The reference chart may enable reproducible analysis of the digital image of the sample, regardless of camera configurations or other external conditions.

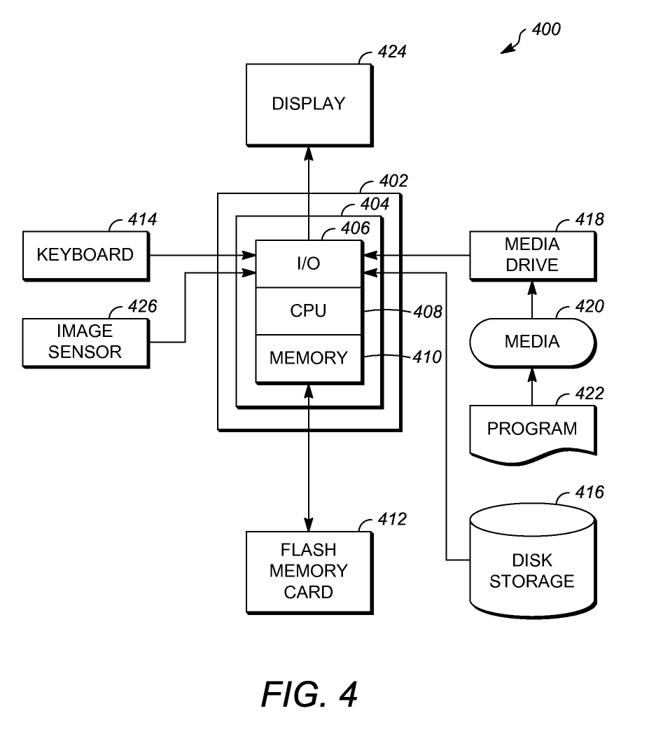

FIG. 4 depicts an exemplary computing system 400 configured to perform any one of the above-described processes. In this context, computing system 400 may include, for example, a processor, memory, storage, and input/output devices (e.g., camera sensor, monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform the above-described processes. The main system 402 includes a motherboard 404 having an input/output (“I/O”) section 406, one or more central processing units (“CPU”) 408, and a memory section 410, which may have a flash memory card 412 related to it. The I/O section 406 is connected to a display 424, an image sensor 426, a keyboard 414, a disk storage unit 416, and a media drive unit 418. The media drive unit 418 can read/write a computer-readable medium 420, which can contain programs 422 and/or data.

In one example, the computing system 400 may include one or more processors and instructions stored in a non-transitory computer-readable storage medium, such as a memory or storage device, that when executed by the one or more processors, perform the processes for determining a light absorption quality, a BC loading value, or a [BC] value as discussed above. In the context of the embodiments described herein, a “non-transitory computer readable-storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette, a random access memory (RAM), a read-only memory (ROM), an erasable programmable read-only memory (EPROM), a portable optical disc such a CD, CD-R, CD-RW, DVD, DVD-R, or DVD-RW, or flash memory such as compact flash cards, secured digital cards, USB memory devices, memory sticks, and the like.

At least some values based on the results of the above-described processes can be saved for subsequent use, such as a BC loading value or [BC] value. Additionally, a non-transitory computer-readable storage medium can be used to store (e.g., tangibly embody) one or more computer programs for performing any one of the above-described processes by means of a computer. The computer program may be written, for example, in a general-purpose programming language (e.g., Pascal, C, C++) or some specialized application-specific language.

Accordingly, digital images of filters that have been exposed to BC, including images that are created by widely available cell phone cameras, may be used to affordably and accurately estimate BC loading in real time or near real time, and may be applied toward determinations of BC emissions.

The use of cell phones permits monitoring of BC to occur on a greater, comprehensive scale because of the ubiquity of cell phones and the wireless networks that they rely on. By taking advantage of existing, widespread wireless technologies and cell phone handsets, this BC measurement process and system may create a real time (or near real time), ultra low-power, affordable, data-gathering mechanism from commonplace technical components that features a readily familiar interface. That familiarity may help non-expert researchers from outside of the scientific community perform BC monitoring in remote and resource-constrained locations (e.g. rural areas) where electrical power is not readily available, broadening the geographic scope of the data-gathering process. A similar approach may be used to collect climate, air pollution, and human behavioral data.

Although certain exemplary embodiments have been described in detail above, those skilled in the art will readily appreciate that many modifications are possible to the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A computer-enabled method of analyzing a sample, the method comprising:
accessing an image comprising a calibration chart region and a representation of the sample, wherein the calibration chart region includes at least two reference markers;
determining reflectance values for each of the at least two reference markers;
associating each of the reference marker reflectance values with reference marker quantity values corresponding to each of the at least two reference markers;
determining an exponential function based on the reference marker reflectance values and the associated reference marker quantity values, wherein the exponential function relates reflectance values with quantity values;
determining a reflectance value for the representation of the sample; and
determining a quantity value of the sample based on evaluating the exponential function using the sample reflectance value.

2. The computer-enabled method of claim 1, wherein:
the exponential function relates reflectance values with quantity values based on the natural exponent (e) raised to the power of the product of an exponent value and an input reflectance value; and
determining the quantity value of the sample comprises using the sample reflectance value as the input reflectance value.

3. The computer-enabled method of claim 2, wherein the exponent value is between −0.001 and −0.1.

4. The computer-enabled method of claim 3, wherein:
determining reflectance values for each of the at least two reference markers comprises determining reflectance values in the red wavelength for each of the at least two references; and
determining a reflectance value for the representation of the sample comprises determining a reflectance value in the red wavelength for the representation of the sample.

5. The computer-enabled method of claim 4, wherein the sample quantity value indicates a black carbon loading of the sample.

6. The computer-enabled method of claim 5, further comprising calculating a black carbon concentration value based on a volume of a gas associated with the sample.

7. The computer-enabled method of claim 2, wherein the exponent value is between −0.01 and −0.02.

8. The computer-enabled method of claim 2, wherein the exponent value is −0.0183.

9. The computer-enabled method of claim 2, wherein the image further comprises a spatial locator.

10. The computer-enabled method of claim 9, wherein the spatial locator is a QR Code.

11. A computer-readable storage medium comprising computer-executable instructions for analyzing a sample, the computer-executable instructions comprising instructions for:
accessing an image comprising a calibration chart region and a representation of the sample, wherein the calibration chart region includes at least two reference markers;
determining reflectance values for each of the at least two reference markers;
associating each of the reference marker reflectance values with reference marker quantity values corresponding to each of the at least two reference markers;
determining an exponential function based on the reference marker reflectance values and the associated reference marker quantity values, wherein the exponential function relates reflectance values with quantity values;
determining a reflectance value for the representation of the sample; and
determining a quantity value of the sample based on evaluating the exponential function.

12. The computer-readable storage medium of claim 11, wherein:
the exponential function relates reflectance values with quantity values based on e raised to the power of the product of an exponent value and an input reflectance value; and
determining the quantity value of the sample comprises using the sample reflectance value as the input reflectance value.

13. The computer-readable storage medium of claim 12, wherein the exponent value is between −0.001 and −0.1.

14. The computer-readable storage medium of claim 13, wherein:
determining reflectance values for each of the at least two reference markers comprises determining reflectance values in the red wavelength for each of the at least two references; and
determining a reflectance value for the representation of the sample comprises determining a reflectance value in the red wavelength for the representation of the sample.

15. The computer-readable storage medium of claim 14, wherein the sample quantity value indicates a black carbon loading of the sample.

16. The computer-readable storage medium of claim 15, the computer-executable instructions further comprising instructions for calculating a black carbon concentration value based on a volume of a gas associated with the sample.

17. The computer-readable storage medium of claim 12, wherein the exponent value is between −0.01 and −0.02.

18. The computer-readable storage medium of claim 12, wherein the exponent value is −0.0183.

19. The computer-readable storage medium of claim 12, wherein the image further comprises a spatial locator.

20. The computer-readable storage medium of claim 19, wherein the spatial locator is a QR Code.

21. A computer system for analyzing a sample, the system comprising:
memory configured to store data; and
one or more processors configured to:
access an image comprising a calibration chart region and a representation of the sample, wherein the calibration chart region includes at least two reference markers;
determine reflectance values for each of the at least two reference markers;
associate each of the reference marker reflectance values with reference marker quantity values corresponding to each of the at least two reference markers;
determine an exponential function based on the reference marker reflectance values and the associated reference marker quantity values, wherein the exponential function relates reflectance values with quantity values;
determine a reflectance value for the representation of the sample;
determine a quantity value of the sample based on evaluating the exponential function using the sample reflectance; and
store the quantity value in the memory.

22. The computer system of claim 21, wherein:
the exponential function relates reflectance values with quantity values based on e raised to the power of the product of an exponent value and an input reflectance value; and
determining the quantity value of the sample comprises using the sample reflectance value as the input reflectance value.

23. The computer system of claim 22, wherein the exponent value is between −0.001 and −0.1.

24. The computer system of claim 23, wherein:
determining reflectance values for each of the at least two reference markers comprises determining reflectance values in the red wavelength for each of the at least two references; and
determining a reflectance value for the representation of the sample comprises determining a reflectance value in the red wavelength for the representation of the sample.

25. The computer system of claim 24, wherein the sample quantity value indicates a black carbon loading of the sample.

26. The computer system of claim 25, the one or more processors further configured to calculate a black carbon concentration value based on a volume of a gas associated with the sample.

27. The computer system of claim 22, wherein the exponent value is between −0.01 and −0.02.

28. The computer system of claim 22, wherein the exponent value is −0.0183.

29. The computer system of claim 22, wherein the image further comprises a spatial locator.

30. The computer system of claim 29, wherein the spatial locator is a QR Code.
